(19) United States
(12) Patent Application Publication
(10) Pub. No.: US 2026/0234028 A1
(43) Pub. Date: Aug. 13, 2026

(54) OUTFLOW FILTER ASSEMBLY FOR A WATER FILTRATION SYSTEM AND A METHOD THEREFOR

(71) Applicant: Keegan Bosch, Henderson, NV (US)

(72) Inventor: Keegan Bosch, Henderson, NV (US)

(21) Appl. No.: 19/051,726

(22) Filed: Feb. 12, 2025

(51) Int. Cl. C02F 1/00

(52) U.S. Cl. CPC C02F 1/001; C02F 2201/004; C02F 2303/24; C02F 2307/14

(57) ABSTRACT

An outflow filter assembly for a water filtration system includes a fitting, a filter unit, and a filter screen. The fitting includes a first fitting end designed to be coupled to a water filtration system and a second fitting end designed to be coupled to plumbing for flow of filtered water to plumbing outlets. The filter unit is inserted in the second fitting end. The filter unit is tubular and has a passage therein. The filter screen is positioned in the passage in the filter body. The filter screen is designed to filter out and trap particulate filter media in filtered water flowing out of the water filtration system to prevent entry of the particulate filter media into the plumbing when a filtration device in the water filtration system is compromised.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to outflow fittings and filters and more particularly pertains to a new outflow filter assembly for preventing entry of particulate filter media into plumbing when a filtration device in a water filtration system is compromised, such as if the filtration device cracks or has a leak somewhere in its housing or filter membrane. In water filtration systems, water flows from an outside source into the plumbing in a building, such as a home or commercial building, into the filtration system, and then into the rest of the plumbing, which leads to the outlets, such as faucets and spigots and output pipes. The filtration device in the filtration system filters out impurities and minerals, usually by flowing the water through particulate filter media in the filtration device. The particulate filter media, such as activated carbon, is granular. In normal operation, some very fine particles of the particulate filter media can usually escape the filtration device, which particles are harmless and usually virtually undetectable. However, if the filtration device is compromised, such as by wear and tear or manufacturing defect, the larger particles or grains of the particulate filter media can escape into the water. These larger or visible particles are easily noticed to alert a person, such as a homeowner or building occupant, of the leakage, but by then the particulate filter media has spread throughout the plumbing, necessitating a flushing of the plumbing, including water tanks, which can be time-consuming and incomplete. The new outflow filter assembly traps these larger particles at the fitting connected to the water filtration system, thereby preventing these larger particles from entering the plumbing when the filtration device is compromised.

### (2) Description of Related Art Including Information Disclosed Under 37 CFR 1.97 and 1.98.

The prior art relates to water filtration systems and filters. The prior art, as best understood, does not disclose an outflow filter assembly for a water filtration system that includes a fitting, a filter unit, and a filter screen, wherein the filter screen is designed to filter out and trap particulate filter media in filtered water flowing out of the water filtration system to prevent entry of the particulate filter media into the plumbing when a filtration device in the water filtration system is compromised.

### BRIEF SUMMARY OF THE INVENTION

An embodiment of the disclosure meets the needs presented above in an outflow filter assembly for a water filtration system generally comprising a fitting, a filter unit, and a filter screen. The fitting includes a first fitting end designed to be coupled to a water filtration system and a second fitting end designed to be coupled to plumbing for flow of filtered water to plumbing outlets. The filter unit is inserted in the second fitting end. The filter unit is tubular and has a passage therein. The filter screen is positioned in the passage in the filter body. The filter screen is designed to filter out and trap particulate filter media in filtered water flowing out of the water filtration system to prevent entry of the particulate filter media into the plumbing when a filtration device in the water filtration system is compromised.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein: FIG. 1 is a top perspective view of a filter unit according to an embodiment of the disclosure.

FIG. 2 is a bottom perspective view of the filter unit of FIG. 1.

FIG. 3 is a top view of the filter unit of FIG. 1.

FIG. 4 is a side cross-sectional view of the filter unit of FIG. 1.

FIG. 5 is a top perspective view of an outflow filter assembly according to an embodiment of the disclosure.

FIG. 6 is a side cross-sectional view of an embodiment of the disclosure.

FIG. 7 is a side view of an embodiment of the disclosure in use.

FIG. 8 is a side view of an embodiment of the disclosure in use.

FIG. 9 is a side view of an embodiment of the disclosure in use.

### DETAILED DESCRIPTION OF THE INVENTION

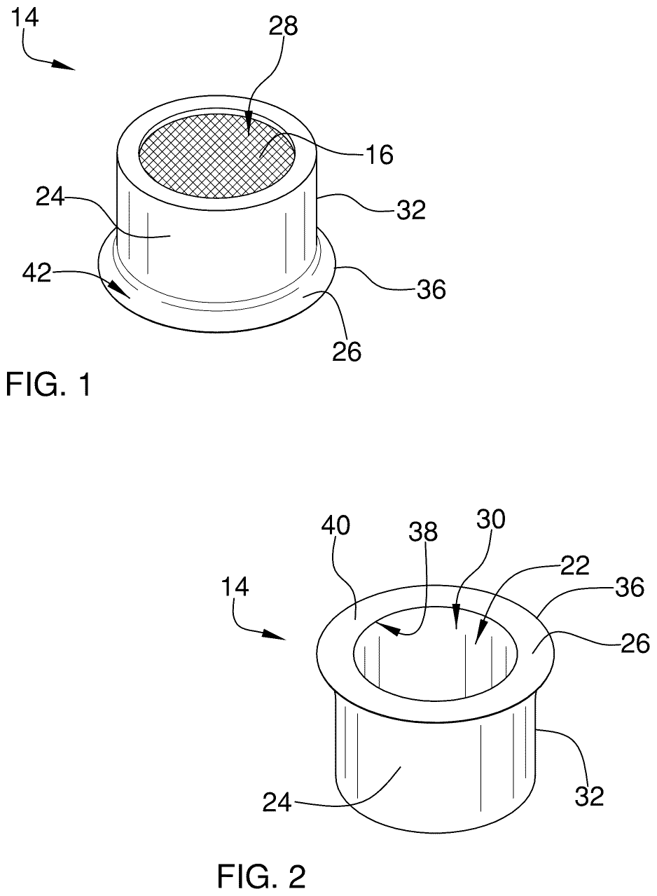

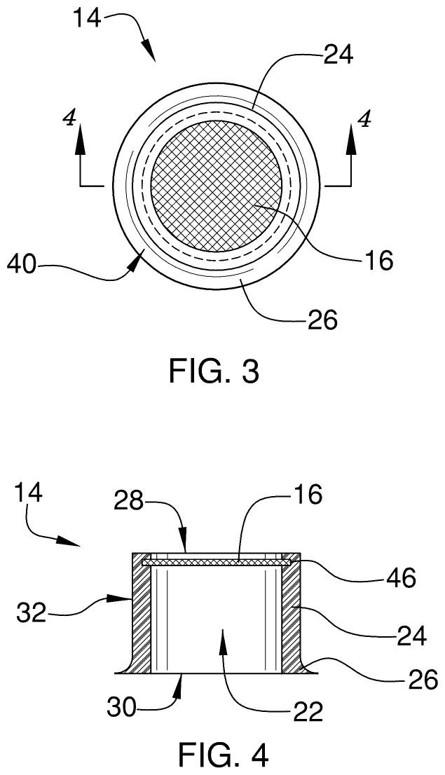

With reference now to the drawings, and in particular to FIGS. 1 through 9 thereof, a new outflow filter assembly embodying the principles and concepts of an embodiment of the disclosure and generally designated by the reference numeral 10 will be described.

As best illustrated in FIGS. 1 through 9, the outflow filter assembly 10 for a water filtration system 60 generally comprises a fitting 12, a filter unit 14, and a filter screen 16. The fitting 12 includes a first fitting end 18 designed to be coupled to a water filtration system 60 and a second fitting end 20 designed to be coupled to plumbing for flow of filtered water 64 to plumbing outlets. The filter unit 14 is inserted in the second fitting end 20. The filter unit 14 is tubular and has a passage 22 therein. The filter screen 16 is positioned in the passage 22 in the filter unit 14. The filter screen 16 is designed to filter out and trap particulate filter media 62 in filtered water 64 flowing out of the water filtration system 60 to prevent entry of the particulate filter media 62 into the plumbing when a filtration device 68 in the water filtration system 60 is compromised.

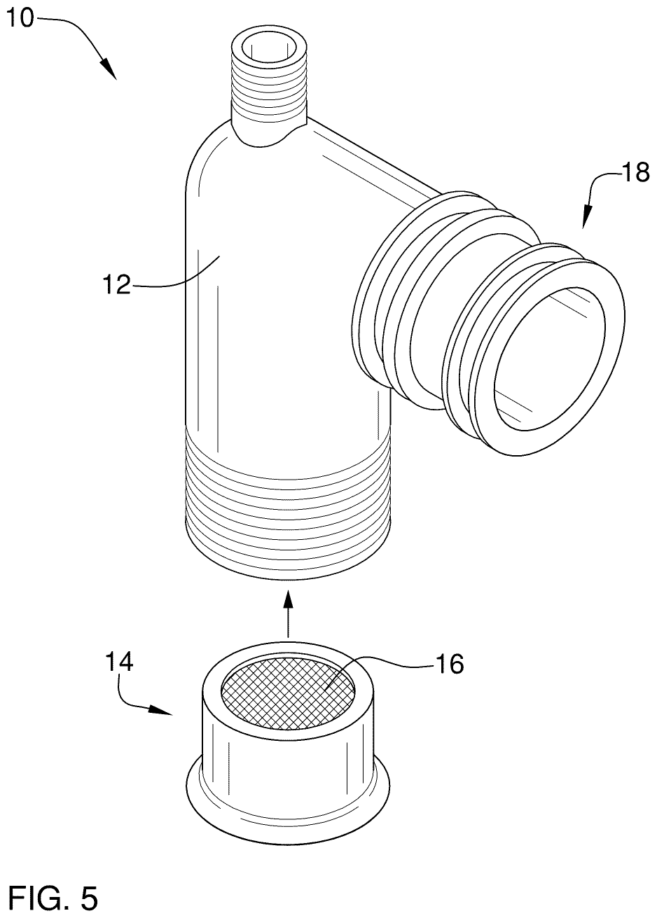

In the exemplary embodiment, as shown in FIGS. 5 through 9, the filter unit 14 is removable from the fitting 12 for removal of the particulate filter media 62 filtered and trapped by the filter screen 16. The user therefore does not need to disconnect the fitting 12 from the water filtration system 60 in order to clean any of the particulate filter media 62 out of the filter screen 16, the filter unit 14, and the fitting 12. It should be noted that the fitting 12 shown in the figures is only one exemplary embodiment of the fitting 12. The filter unit 14 can be designed for and used with various types of fittings.

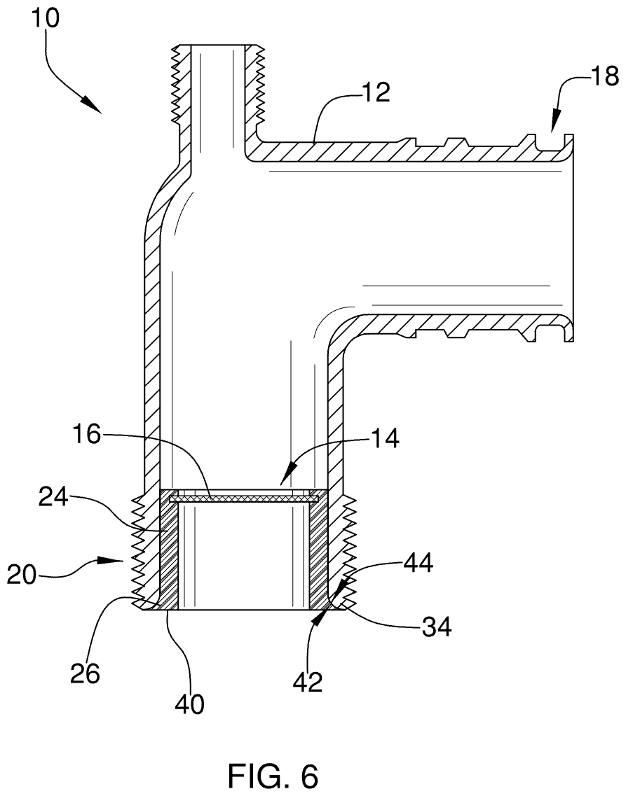

The filter unit 14 includes a body portion 24 and a lip portion 26. The body portion 24 includes a first aperture 28 and a second aperture 30. The lip portion 26 is positioned about the second aperture 30. The lip portion 26 is designed to project annularly beyond an outer wall surface 32 of the body portion 24. As shown in FIG. 6, the lip portion 26 is seated against a rim 34 of the second fitting end 20. The lip portion 26 prevents the filter unit 14 from being pushed completely into the fitting 12 and promotes a seal against leakage of water.

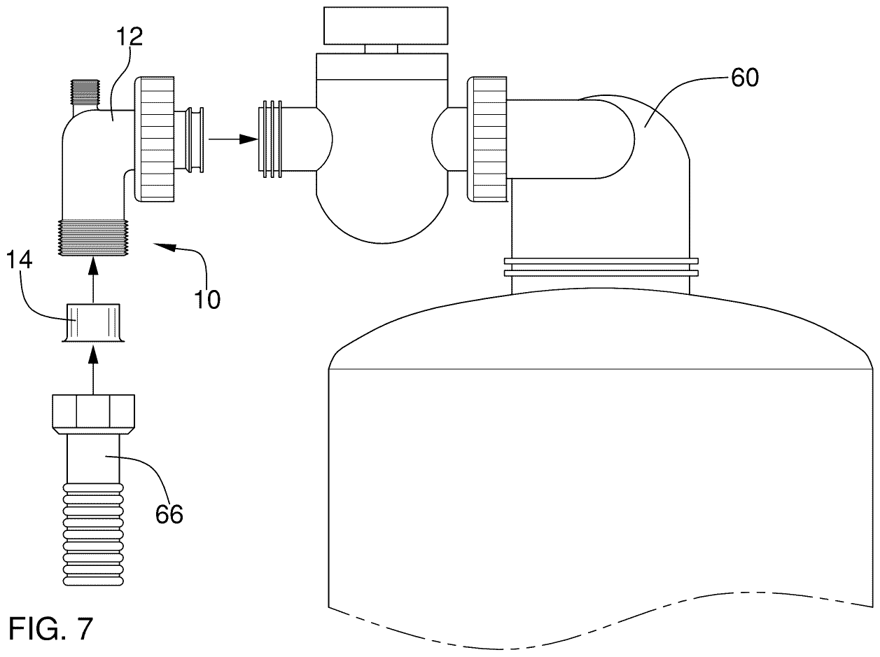

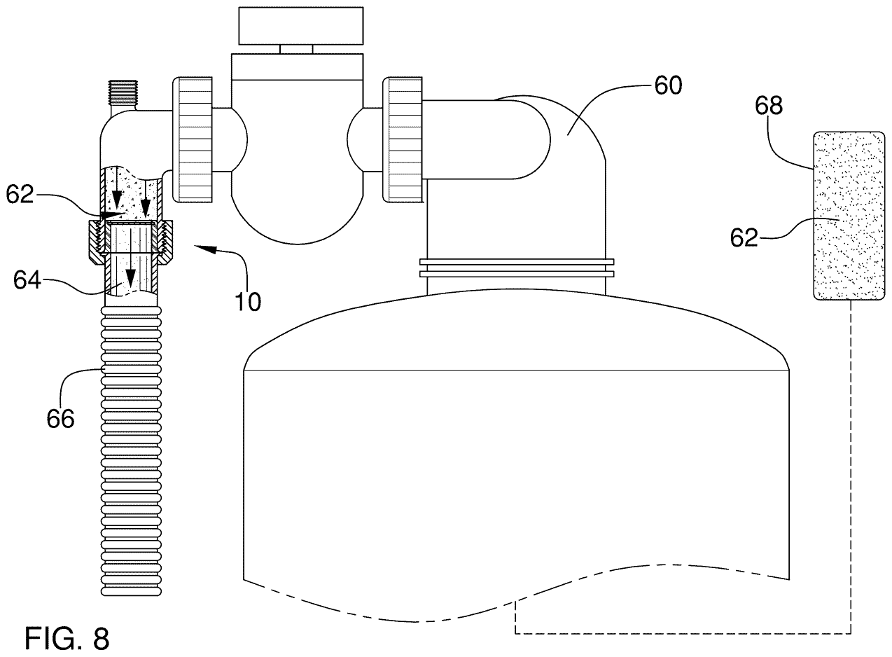

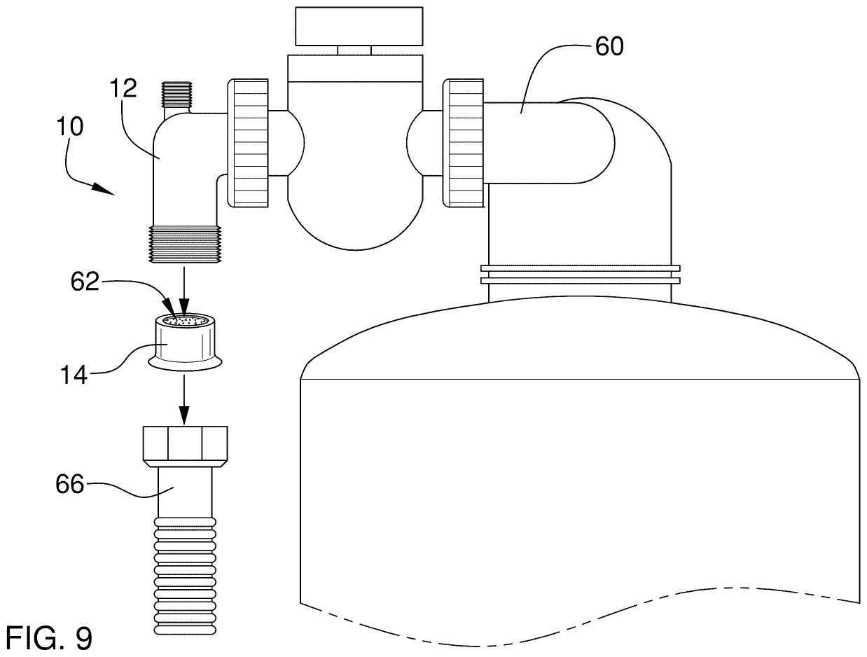

In the exemplary embodiment, the lip portion 26 includes an outer lip edge 36, an inner lip edge 38, and a lip end face 40 between the outer lip edge 36 and the inner lip edge 38. The lip portion 26 includes an outer lip surface 42 from the outer lip edge 36 to the outer wall surface 32 of the body portion 24. The outer lip surface 42 is concave and designed to follow an inner surface 44 of the rim 34 of the second fitting end 20 that is convex, such that the lip end face 40 is positioned flush with the rim 34 of the second fitting end 20. As shown in FIG. 6, the rim 34 of the second fitting end 20 is convex or rounded, so the outer lip surface 42 is concave or rounded to produce a matching engagement and seal. This design also allows the filter unit 14 to be seated essentially completely within the fitting 12 such that the filter unit 14 does not project out of the fitting 12, or at least projects out minimally, such that the lip end face 40 is flush with the rim 34 of the second fitting end 20. This design allows a section of the plumbing, such as a flex hose 66 shown in FIGS. 7 through 9, to couple with the second fitting end 20 without any interference from the filter unit 14. As shown in FIG. 8, for example, the flex hose 66 is fully screwed onto the second fitting end 20 in a fully sealed engagement. However, in another possible embodiment, the lip portion 26 of the filter unit 14 could be rectangular or have squared corners, depending on the design of the rim 34 of the second fitting end 20. The lip portion 26 of the filter unit 14 could also include a seal, like an O-ring or similar. The lip portion 26 of the filter unit 14 can be modified as needed during manufacture to best seal the type of the fitting 12 into which in the filter unit 14 will be inserted.

In the exemplary embodiment in FIG. 1, the filter screen 16 is positioned at the first aperture 28. In another possible embodiment, the filter screen 16 is positioned at the second aperture 30, or could be positioned at any location in a central portion of the body portion 24 of the filter unit 14. In the exemplary embodiment in FIG. 4, the filter unit 14 includes an annular recess 46 in an inner wall surface of the body portion 24 adjacent the first aperture 28. The filter screen 16 is mounted in the annular recess 46. In another possible embodiment, the filter screen 16 could be formed integrally with or bonded to the body portion 24 of the filter unit 14.

As discussed above, the filter screen 16 is designed to filter out and trap the particulate filter media 62. In one embodiment, the filter screen 16 is designed to filter out and trap the particulate filter media 62 having a particle size of 0.15 mm to 1.0 mm. In another embodiment, the filter screen 16 is designed to filter out and trap the particulate filter media 62 having a particle size of 0.3 mm to 0.8 mm. The filter screen 16 can be selected to filter out and trap the particulate filter media 62 of whatever size is appropriate for the particulate filter media 62 to be trapped.

The filter unit 14 is made of plastic, though in another possible embodiment the filter unit 14 could be made of metal or a combination of metal and plastic. The filter screen 16 is made of metal, plastic, or a combination of metal and plastic. The filter unit 14 could be made of a plastic or elastomer, such as soft or resilient plastic or elastomer, to promote a friction fit or form fit with the fitting 12 to retain the filter unit 14 in the fitting 12.

The outflow filter assembly 10 is used to prevent entry of the particulate filter media 62 into the plumbing when the filtration device 68 in the water filtration system 60 is compromised, such as if the filtration device 68 cracks or has a leak somewhere in its housing or filter membrane. In such a situation, the larger grains of the particulate filter media 62, such as activated carbon, in the filtration device 68 are allowed to escape into the water flowing through the water filtration system 60. As shown in the exemplary embodiment in FIGS. 7 through 9, the first fitting end 18 of the fitting 12 is coupled to the water filtration system 60. A flexible hose is connected to plumbing and coupled to the second fitting end 20 of the fitting 12. The water filtration system 60 is then operated as normally to flow filtered water 64 into the plumbing. If the filtration device 68 is compromised, the filter screen 16 filters out and traps the particulate filter media 62 with the filter screen 16 and thereby prevents trapped particulate filter media 62 from entering the plumbing. As discussed above, without the filter screen 16, the particulate filter media 62 would freely flow throughout the plumbing. At some point after the filtration device 68 is compromised and leaking the particulate filter media 62, a person, such as a homeowner or commercial building occupant, will either detect a leak of particulate filter media 62 out of a filtration device 68 in the water filtration system 60, such as by seeing an increased amount of fine particles of the particulate filter media 62, small enough to pass through the filter screen 16, in the filtered water 64 exiting the plumbing outlets, such as a faucet or spigot, or will detect a reduced flow of filtered water 64 out of the plumbing, indicating that the particulate filter media 62 has accumulated at the filter screen 16 and is inhibiting flow of filtered water 64. The user or a service technician can then turn off flow of water through the fitting 12 and decouple the flexible hose from the fitting 12. The filter unit 14 is then inspected and any particulate filter media 62 trapped in the filter unit 14 and the fitting 12 is cleaned out. The user or the service technician can then repair the water filtration system 60, such as by replacing the filtration device 68, then reassemble and reconnect any disconnected parts to operate the water filtration system 60 as normal. In the exemplary embodiment, in FIGS. 7 through 9, the filter unit 14 can be removed from the fitting 12, cleaned out of any of the particulate filter media 62, and then inserted back into the fitting 12, all without decoupling or disconnecting the fitting 12 from the water filtration system 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1-18. (canceled)

19. An outflow filter device for a water filtration system comprising:
a filter unit, the filter unit being configured to be installed in a conduit connecting a water filtration system to plumbing for flow of filtered water to plumbing outlets, the filter unit being tubular and having a passage therein; and
a filter screen, the filter screen being positioned in the passage in the filter unit, the filter screen being configured to filter out and trap particulate filter media in filtered water flowing out of the water filtration system to prevent entry of the particulate filter media into the plumbing when a filtration device in the water filtration system is compromised.

20. The outflow filter device of claim 19, wherein the filter unit is removable for removal of the particulate filter media filtered and trapped by the filter screen.

21. The outflow filter device of claim 19, wherein:
the filter unit includes a body portion and a lip portion;
the body portion includes a first aperture and a second aperture;
the lip portion is positioned about the second aperture; and
the lip portion is configured to project annularly beyond an outer wall surface of the body portion.

22. The outflow filter device of claim 21, wherein the filter screen is positioned at the first aperture.

23. The outflow filter device of claim 21, wherein:
the filter unit includes an annular recess in an inner wall surface of the body portion adjacent the first aperture; and
the filter screen is mounted in the annular recess.

24. The outflow filter device of claim 21, wherein:
the lip portion includes an outer lip edge, an inner lip edge, and a lip end face between the outer lip edge and the inner lip edge;
the lip portion includes an outer lip surface from the outer lip edge to the outer wall surface of the body portion; and
the outer lip surface is concave.

25. The outflow filter device of claim 19, wherein the filter screen is configured to filter out and trap the particulate filter media having a particle size of 0.15 mm to 1.0 mm.

26. The outflow filter device of claim 19, wherein the filter screen is configured to filter out and trap the particulate filter media having a particle size of 0.3 mm to 0.8 mm.

27. The outflow filter device of claim 19, wherein:
the filter unit is made of plastic; and
the filter screen is made of metal, plastic, or a combination of metal and plastic.

28. The outflow filter device of claim 20, wherein:
the filter unit includes a body portion and a lip portion;
the body portion includes a first aperture and a second aperture;
the lip portion is positioned about the second aperture; and
the lip portion is configured to project annularly beyond an outer wall surface of the body portion.

29. The outflow filter device of claim 28, wherein the filter screen is positioned at the first aperture.

30. The outflow filter device of claim 29, wherein:
the filter unit includes an annular recess in an inner wall surface of the body portion adjacent the first aperture; and
the filter screen is mounted in the annular recess.

31. The outflow filter device of claim 30, wherein:
the lip portion includes an outer lip edge, an inner lip edge, and a lip end face between the outer lip edge and the inner lip edge;
the lip portion includes an outer lip surface from the outer lip edge to the outer wall surface of the body portion; and
the outer lip surface is concave.

32. The outflow filter device of claim 31, wherein:
the filter unit is made of plastic; and
the filter screen is made of metal, plastic, or a combination of metal and plastic.

33. The outflow filter device of claim 32, wherein the filter screen is configured to filter out and trap the particulate filter media having a particle size of 0.15 mm to 1.0 mm.

34. The outflow filter device of claim 32, wherein the filter screen is configured to filter out and trap the particulate filter media having a particle size of 0.3 mm to 0.8 mm.

35. A method of preventing entry of particulate filter media into plumbing when a filtration device in a water filtration system is compromised, the method comprising the steps of:
providing an outflow filter device for a water filtration system comprising:
a filter unit, the filter unit being configured to be installed in an end of a conduit connecting a water filtration system to plumbing for flow of filtered water to plumbing outlets, the filter unit being tubular and having a passage therein; and
a filter screen, the filter screen being positioned in the passage in the filter unit, the filter screen being configured to filter out and trap particulate filter media in filtered water flowing out of the water filtration system to prevent entry of the particulate filter media into the plumbing when a filtration device in the water filtration system is compromised;
providing a fitting, the fitting including a first fitting end being configured to be coupled to a water filtration system and a second fitting end being configured to be coupled to plumbing for flow of filtered water to plumbing outlets;
inserting the filter unit into the second fitting end;
coupling the first fitting end of the fitting to the water filtration system;
coupling a flexible hose connected to plumbing to the second fitting end of the fitting;
operating the water filtration system to flow filtered water into the plumbing;
filtering out and trapping the particulate filter media with the filter screen and thereby preventing trapped particulate filter media from entering the plumbing;
detecting a leak of particulate filter media out of a filtration device in the water filtration system or detecting reduced flow of filtered water out of the plumbing;
turning off flow of water through the fitting;
decoupling the flexible hose from the fitting; and
inspecting the filter unit and cleaning trapped particulate filter media from the filter unit and the fitting.

36. The method of claim 35, wherein the filter unit is removable from the fitting, and the step of cleaning trapped particulate filter media includes removing the filter unit from the fitting, cleaning out the particulate filter media, and then inserting the filter unit back into the fitting without decoupling the first fitting end of the fitting from the water filtration system.
